(19) United States
(12) Patent Application Publication
(10) Pub. No.: US 2012/0304954 A1
(43) Pub. Date: Dec. 6, 2012

(54) CYLINDER LINER WITH A CASE ON A CUFF-RING GROOVE

(75) Inventors: MATTHEW THOMAS KISER, Chillicothe, IL (US); JAMES W. GEE, Washington, IL (US); SCOTT DAVID PERKINS, Eureka, IL (US); MAGGIE R. BURROW, Peoria, IL (US)

(73) Assignee: Caterpillar Inc.

(21) Appl. No.: 13/151,441

(22) Filed: Jun. 2, 2011

(51) Int. Cl. F02F 1/00; B23P 11/00

(52) U.S. Cl. 123/193.2; 29/888.06

(57) ABSTRACT

A cylinder liner for an engine includes a hollow cylindrical sleeve, with an inner surface and an outer surface, that extends from a first end to a second end along a longitudinal axis. The cylinder liner may also include an annular cuff-ring groove, with a radiused fillet region, on the inner surface proximate the first end. The cylinder liner may further include a hardened case formed on the inner surface of the sleeve. The case may extend under a base of the fillet region of the cuff-ring groove.

### TECHNICAL FIELD

The present disclosure relates generally to a cylinder liner for an internal combustion engine, and more particularly, to a cylinder liner with a case on at least a portion of a cuff-ring groove.

### BACKGROUND

An internal combustion engine, such as a diesel or gasoline engine, includes a cylinder block defining a plurality of cylinder bores. Pistons reciprocate within the cylinder bores to generate mechanical power. Typically, each cylinder bore includes a replaceable cylinder liner. The cylinder liner includes a cylindrical sleeve that fits within the cylinder bore. The cylinder liner may also include a radial flange, at its top end, that supports the liner on the engine block. The inner surface of the cylinder liner (called, a running surface) serves as a sliding surface for the piston rings. Because the piston rings slide on the running surface during the operation of the engine, the cylinder liner may wear over time. When the liner wear detrimentally affects the performance of the engine, the liners may be replaced with a new or a refurbished liner.

In general, cylinder liners may be made of steel or cast iron. Steels and cast irons are both primarily iron, with carbon as the main alloying element. Steels contain less than 2% (usually less than 1%) carbon, while cast irons contain more than 2% carbon. Since 2% is about the maximum carbon content at which iron can solidify as a single-phase alloy, cast irons solidify as heterogeneous alloys with carbon (as graphite) in their microstructure. The graphite in cast iron acts as a lubricant and provides wear resistance in a cylinder liner application. Based on the morphology of graphite in the microstructure, cast irons may be classified as gray iron, vermicular iron, or ductile iron. In gray (or flake) iron, the graphite exists in the form of flakes. In ductile iron (or nodular iron), graphite exists in the form of small spheres. Having graphite in the form of spheres improve the stiffness, strength, and shock resistance of ductile iron over gray iron. Therefore, in applications requiring higher strength, cylinder liners may be fabricated from ductile iron. To increase the wear resistance of the liner, the running surface of the liner may be hardened by induction hardening.

During installation of the liner in the engine block, and during operation of the engine, high stresses may be induced in the liner. These stresses may be especially high near the base, or the root, of the flange that supports the cylinder liner on the engine block. Because of these high induced stresses, regions proximate the flange root are prone to fatigue failure. Therefore, various strengthening operations may be performed on the liner to increase the strength of the liner in this critical region. U.S. Pat. No. 6,732,699 (the '699 patent) discloses a cast iron cylinder liner with a radial upper flange having an arcuate fillet formed at the junction between the flange and the exterior surface of the liner. In the liner of the '699 patent, a portion of the material adjacent to the arcuate fillet (that is, flange root) is laser hardened to increase the fatigue resistance of the material in this region. While laser hardening the flange root may increase the fatigue life of the cylinder liner, this approach may not be suitable in some applications. For instance, implementation of a post manufacturing operation, such as laser hardening, may increase the cost of the cylinder liner. Additionally, in some applications, a potential failure initiation site of the cylinder liner may not be easily accessible for laser hardening.

The present disclosure is directed to overcoming these or other limitations in existing technology.

### SUMMARY

In one aspect, a cylinder liner for an engine is disclosed. The cylinder liner may include a hollow cylindrical sleeve, with an inner surface and an outer surface, that extends from a first end to a second end along a longitudinal axis. The cylinder liner may also include an annular cuff-ring groove, with a radiused fillet region, on the inner surface proximate the first end. The cylinder liner may further include a hardened case formed on the inner surface of the sleeve. The case may extend under a base of the fillet region of the cuff-ring groove.

In another aspect, a method of making a cylinder liner is disclosed. The method may include fabricating a hollow cylindrical sleeve, with an inner surface and an outer surface, that extends from a first end to a second end along a longitudinal axis. The method may also include forming a hardened case on the inner surface of the sleeve, such that a thickness of the case proximate the first end is greater than a thickness of the case on other regions of the inner surface. The method may further include machining a cuff-ring groove on the inner surface of the sleeve proximate the first end such that at least a portion of the case on a base of the cuff-ring groove is retained after the machining.

In yet another aspect, an engine is disclosed. The engine may include an engine block including one or more cylinder bores, and a cylinder liner positioned in at least one of the cylinder bores. The cylinder liner may include a hollow cylindrical sleeve with an inner running surface extending from a first end to a second end along a longitudinal axis, and an annular cuff-ring groove that extends from the first end towards the second end. The engine may also include a hardened case formed on the running surface by surface hardening. The case may extend under at least a portion of the cuff-ring groove. The engine may further include an anti polish ring, or a cuff-ring, positioned in the cuff-ring groove.

### BRIEF DESCRIPTION OF THE DRAWINGS

FIG. 1 is a cross-sectional view of part of an engine 10 with a cylinder liner 12;

FIG. 2A is an cross-sectional illustration of a portion of a prior art cylinder liner 12;

FIG. 2B is an enlarged view of the fillet region of the cuff-ring groove of the prior art cylinder liner of FIG. 2A;

FIG. 3 is a cross-sectional view of a portion of the cylinder liner of FIG. 1; and

FIG. 4 is a flow chart illustrating an exemplary method of making the cylinder liner of FIG. 3.

### DETAILED DESCRIPTION

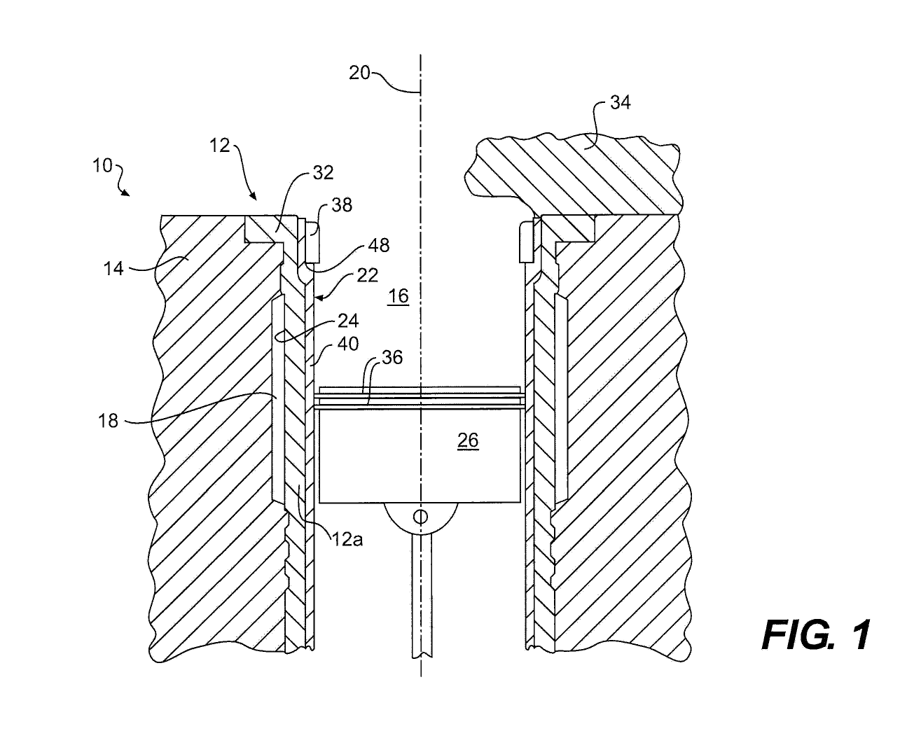

FIG. 1 is a cross-sectional view of part of an engine 10 with a cylinder liner 12 (“liner 12”). Engine 10 includes an engine block 14 comprising a piston bore 16. Liner 12 may be removably mounted in the piston bore 16. Liner 12 has a hollow generally cylindrical body extending along a longitudinal axis 20 with an inner running surface 22 and an outer surface 24. Liner 12 also includes an annular flange 32 extending radially from a top end of the liner 12. An outer surface of the flange 32 mates with an annular step-like mounting surface formed in engine block 14. Although a liner 12 that is supported on the engine block 14 by a flange 32 is illustrated herein, liner 12 can also be supported on the engine block 14 by other methods. For instance, in some embodiments, liner 12 may be press-fitted on the bore 16. In these embodiments, liner 12 may not include a flange 32. A cylinder head 34, secured to the engine block 14, encloses a combustion chamber of the engine 10 within the bore 16. The combustion chamber is bounded on the sides by the running surface 22 of the liner 12. During operation of the engine 10, combustion that occurs in the combustion chamber heats the liner 12. Engine block 14 may include a water jacket cavity 18, which circulates water along the outer surface 24, to cool the liner 12. In some embodiments, the liner may be cooled by other methods.

Liner 12 may be made of any type of steel or cast iron. In some embodiments, liner 12 may be made of ductile, or nodular, iron. It is also contemplated, that in some embodiments, liner 12 may be made of steel or another type of cast iron, such as gray iron or vermicular iron. In some embodiments with steel liners, as described in co-pending U.S. application Ser. No. 13/036,249, a lamellar annealing step of the steel may be replaced by a normalizing heat treat step. The specification of U.S. application Ser. No. 13/036,249 is incorporated herein by reference, in its entirety.

As is known in the art, a piston 26 may reciprocate in the piston bore 16 between a top dead center (TDC) position proximate the top of the liner and a bottom dead center (BDC) position proximate a bottom of the liner 12. As the piston 26 reciprocates, piston rings 36 (of a piston 26) slide on the running surface 22 of the liner 12. Due to repeated sliding of the piston rings 36 on the running surface 22, the running surface 22 may be subjected to abrasive wear. To improve the wear resistance of the running surface 22, running surface 22 may include a hardened shell or a case 40. Case 40 is a surface region of the running surface 22 in which the crystalline structure of the liner material is transformed to be substantially martensite by the application of heat. Case 40 may be formed by any surface hardening process, such as, for example, flame hardening, induction hardening, laser hardening, or any other known surface hardening process.

To form case 40, the running surface 22 of the liner 12 is heated to a high temperature and then cooled rapidly to create a “case” containing substantially martensite on the surface. As is known in the art, when an iron alloy (steel, cast iron, etc.) is heated to a temperature in the austenitic range of the alloy and held at this temperature for a sufficient time, the crystal structure of the iron alloy changes to an austenite structure. When the alloy is then is quenched (or rapidly cooled), the carbon atoms do not have time to diffuse out of the crystal structure and forms martensite. This transformation to martensite begins during cooling when the austenite reaches the martensite start temperature and ends at the martensite finish temperature. Martensite is a crystal structure that is hard and wear resistant. Therefore, case 40 provides wear resistance to the running surface 22.

In some embodiments, an induction hardening process is used to transform a layer of material on the surface of the running surface 22 into case 40. Induction hardening uses the principle of electromagnetic induction to heat the running surface 22 of liner 12. As known in the art, in induction hardening, an induction coil scans the inside surface of the liner 12 to apply an alternating magnetic field on the running surface 22, to heat the running surface 22 and form the case 40 thereon. By varying parameters of the scanning (such as, frequency, power level, scan speed, etc.), case 40 of a desired depth may be formed on the running surface 22. The depth of the case 40 may be varied by changing the frequency, the power level, or the scan rate of the coil. While a thick case 40 may seem desirable from a wear life point of view, it may have undesirable side effects. For instance, increasing the thickness of the case 40 may require increasing the thickness of the liner 12. Increasing the thickness of the liner 12 may undesirably increase the weight of the liner 12. Further, a thicker case 40 may have an undesirable impact on stresses in the liner. Therefore, the thickness of the case 40 is selected to achieve the beneficial increase in wear life while minimizing undesirable side effects. Although FIG. 1 illustrates the running surface 22 as having a distinct layer of case 40 on a base material 12a of the liner 12, in some embodiments, a transition layer may be present between the base material 12a and the case 40.

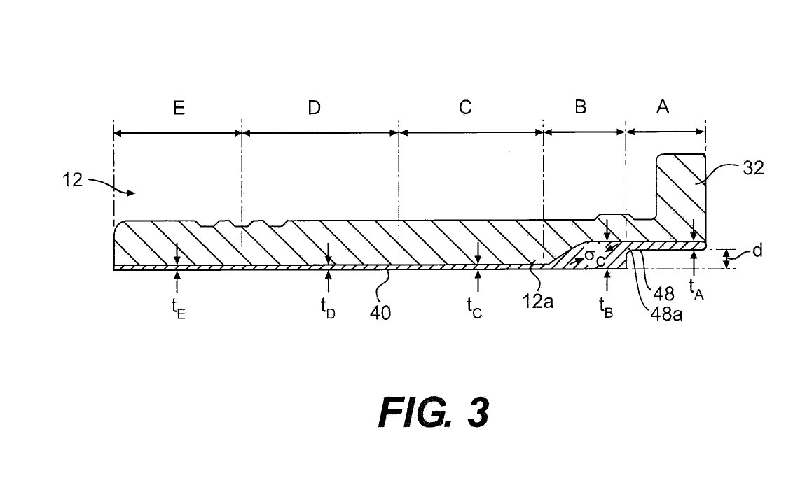

Liner 12 may include an anti-polish or a cuff-ring 38 located in a cuff-ring groove 48 proximate the TDC. Although the cuff-ring groove 48 may be of any shape, in some embodiments, the cuff-ring groove 48 may be a step-like groove that extends from a top end of the sleeve. The cuff-ring 38 may assist in reducing the wear of the liner 12 by scraping off some of the combustion products that deposit on a top rim of the piston 26 during operation of the engine 10. Typically, a machining operation forms the cuff-ring groove 48 after the case 40 is formed. During formation of the cuff-ring groove 48, a radiused fillet region 48a (see FIG. 3) may also be formed at the junction between the walls of the cuff-ring groove 48. Due to the proximity of the cuff-ring groove 48 to the flange 32, it is known that the fillet region 48a of the cuff-ring groove 48 is a high stress region, that may act as fatigue crack initiation site in liner 12.

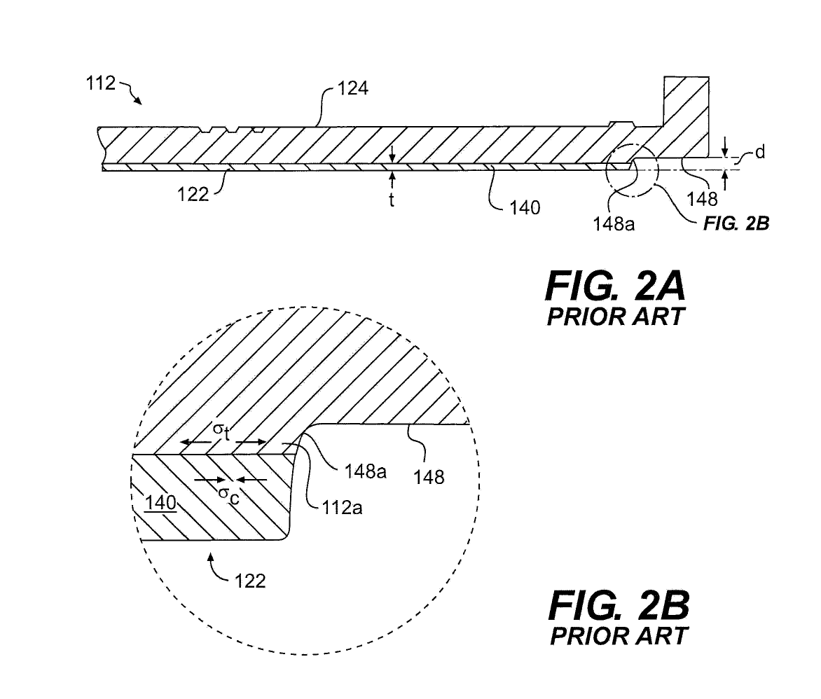

FIG. 2A illustrates a cross-section of a portion of a prior art liner 112 with a case 140 formed thereon. Typical prior art liners 112 have a case 140 with a constant thickness “t” along the length of the liner 112. Typically, as illustrated in FIG. 2A, the thickness t of the case 140 is smaller than the depth “d” of a cuff-ring groove 148 of the liner 112. Therefore, the machining operation completely removes the case 140 from the top end of the liner 112 to form the cuff-ring groove 148. As illustrated in FIG. 2B, the induction hardening operation, that forms the case 140, induces residual compressive stresses σ_{c} in the case 140. To balance these compressive stresses σ_{c}, tensile stresses σₜ are induced in the underlying base material 112a of the liner 112. Removal of the case 140 from the cuff-ring groove 148 relieves the tensile stresses σₜ from the base material 112a in this region. However, the base material 112a in the fillet region 148a of the cuff-ring groove 148 will still experience residual tensile stresses σₜ due to the presence of the case 140 in regions adjacent to the fillet region 148a. It is known that residual tensile stresses accelerate fatigue crack initiation and propagation, and are therefore undesirable in a location that is prone to fatigue failure.

FIG. 3 illustrates a cross-section of a portion of an exemplary cylinder liner 12 of the current disclosure with a case 40 formed thereon. The thickness of case 40 varies along the length of the liner 12. In a region A associated with the cuff-ring groove 48, case 40 may have a thickness t_{A}, and in regions B, C, D, and E of the liner 12, the case 40 may have thicknesses t_{B}, t_{C}, t_{D}, and t_{E}, respectively. Although FIG. 3 illustrates region A as covering the entire length of the cuff-ring groove 48, it is contemplated that in some embodiments, region A may only cover the base of the fillet region 48a, and not the entire length of the cuff-ring groove 48. As explained earlier, case 40 may have compressive stresses σ_{c} induced therein. Therefore, by having a case 40 in the fillet region 48a, the residual stresses on the exposed surface of the fillet region 48a are transformed from tensile (in prior art liner 112) to compressive. It is known that compressive residual stresses delay fatigue crack initiation and propagation. Therefore, the case 40 in the fillet region 48a improves fatigue life of the liner 12.

Although five different regions A, B, C, D, and E are illustrated in FIG. 3, some embodiments of liner 12 may include a different number (less or more) of regions. For instance, in some embodiments, the liner 12 may only include three regions. In some such embodiments, the thickness of the case 40 in some of the regions may be substantially the same. For instance, in some embodiments, the thickness of case 40 in regions C, D, and E may be substantially the same (that is, t_{C}≈t_{D}≈t_{E}). The thicknesses t_{A}, t_{B}, t_{C}, t_{D}, and t_{E} may have any value that provides sufficient wear resistance while minimizing undesirable side effects. In some embodiments, t_{A} may be between about 0.5 and 1.5 mm, thickness t_{B} may be between about 0.7 and 3.5 mm, and thicknesses t_{C}, t_{D}, and t_{E} may be between about 0.7 and 1.8 mm. In some embodiments, t_{A} may be between about 1.0 and 1.5 mm, thickness t_{B} may be between about 2.0 and 3.0 mm, and thicknesses t_{C}, t_{D}, and t_{E} may be between about 1.0 and 1.8 mm. In some other embodiments, t_{A} may be between about 1.1 and 1.3 mm, thickness t_{B} may be between about 2.0 and 2.5 mm, and thicknesses t_{C}, t_{D}, and t_{E} may be between about 1.4 and 1.8 mm. Although any values of thicknesses (t_{A}, t_{B}, t_{C}, t_{D}, and t_{E}) of the case 40 are possible, and are within the scope of this disclosure, the above-recited thicknesses are expected to provide sufficient wear resistance while reducing undesirable side effects. The thickness of the case 40 in a region may be substantially a constant, or may vary between different values. For instance, in some embodiments, the thickness of case 40 in region A may vary from a minimum value of about 0.5 mm to a maximum value of 1.5 mm.

### INDUSTRIAL APPLICABILITY

The disclosed cylinder liner may be applied in any application where it is desired to increase the fatigue life of the cylinder liner. A case is formed on the running surface of the cylinder liner by surface hardening. In an exemplary embodiment of a cylinder liner with a cuff-ring groove, the case extends under a base of the fillet region of the cuff-ring groove. To form the case under the base of the fillet region, in some embodiments, a thicker case (as compared to other regions) is formed in the region of the cylinder liner where the cuff-ring will subsequently be formed. A machining operation is then used to form the cuff-ring groove while retaining at least a portion of the case at the base of the fillet region of the cuff-ring groove. However, other embodiments in which the case under the base of the fillet region is formed after the cuff-ring groove is machined, are also contemplated. An exemplary method of producing a disclosed cylinder liner will now be described.

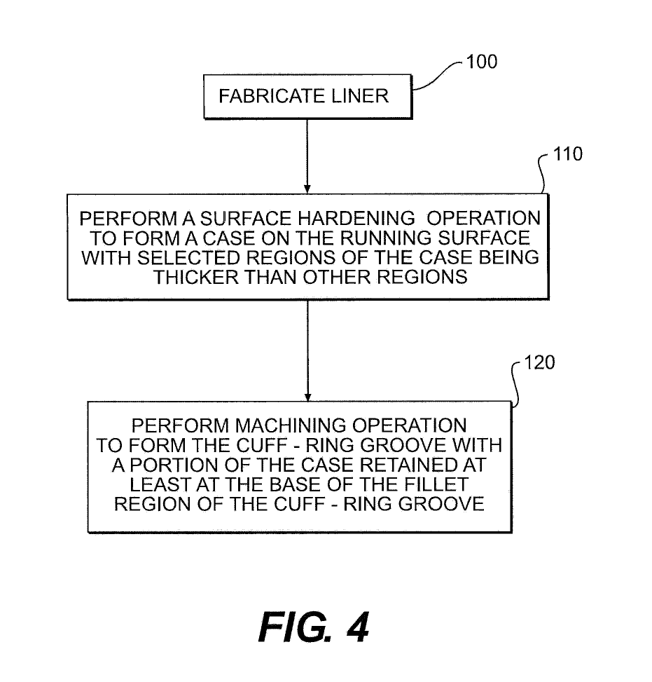

FIG. 4 discloses an exemplary method of producing a cylinder liner 12 of the current application. The liner 12 is first fabricated by any known process (step 100). In some embodiments, in place of fabricating a new liner 12, a previously used liner 12 may be refurbished. In these embodiments, a liner 12 that was previously used in an engine 10 may be cleaned, and its running surface 22 prepared for applying a case 40 thereon. Preparation of the running surface 22 may involve degreasing and removal of remnants, if any, of a previous case from the running surface 22. A surface hardening operation (such as, for example, induction hardening) is then performed to transform a surface layer of material on the running surface 22 into case 40. A thicker case 40 is formed in selected regions of the running surface 22 as compared to other regions of the running surface 22. In an embodiment where case 40 is formed by induction hardening, a thicker case 40 in selected regions is formed by varying the parameters of the induction hardening process (step 110). For instance, with reference to FIG. 3, a thicker case 40 is formed in region A, by decreasing the frequency of the alternating magnetic field applied to this region, increasing the power level of the magnetic field applied to this region, and/or decreasing the scan speed of the induction coil in this region. After case 40 having a desired depth in regions A, B, C, D, and E is formed, the cuff-ring groove 48 is formed by one or more machining operations. These machining operations may include any known machining operation. During the machining operations, some of the case 40 is removed from the top end of the running surface 22 to form the cuff-ring groove 48. However, because of the thicker case 40 in region A, a portion of the case 40 may be retained in at least the fillet region 48a of the cuff-ring groove 48 (step 120). In embodiments, where the thickness of the case 40 formed in an entire length of the cuff-ring groove 48 is greater than the depth d of the cuff-ring groove 48, a portion of the case 40 will be retained along the entire length of the cuff-ring groove 48. However, in embodiments where only the thickness of the case 40 formed in the fillet region 48a is greater than the depth d of the cuff-ring groove 48, a portion of the case 40 will be retained only at the base of the fillet region 48a. Since the case 40 is formed in the fillet region 48a by modifying an existing process step (that is, without an additional process step), cost is reduced. In some embodiments, in addition to (or instead of) forming a thicker case in region A of the liner 12 before the cuff-ring groove 48 is machined, a process, such as, a laser or a torch hardening process may be used to form a case 40 in the fillet region 48a after the cuff-ring groove 48 is machined.

An exemplary method of using a disclosed cylinder liner 12 may include installing a liner 12, with a case 40 on the running surface 22, on an engine 10. The liner 12 may include a newly fabricated or a refurbished liner 12 having the case 40 at least at the base of the fillet region 48a of the cuff-ring groove 48 of the liner 12. A cuff-ring 38 is then positioned on the cuff-ring groove 48, and the engine 10 assembled. The engine 10 is then operated. Since the residual stress state at the base of the fillet region 48a is compressive, initiation (if any) of a fatigue crack in this region will be delayed. Furthermore, if a fatigue crack is initiated in the fillet region 48a, the residual compressive stresses in this region will slow the progression of the crack. Fatigue life of the liner 12 is thus improved.

It will be apparent to those skilled in the art that various modifications and variations can be made to the disclosed cylinder liner. Other embodiments will be apparent to those skilled in the art from consideration of the specification and practice of the disclosed cylinder liner. It is intended that the specification and examples be considered as exemplary only, with a true scope being indicated by the following claims and their equivalents.

What is claimed is:

1. A cylinder liner for an engine, comprising:
a hollow cylindrical sleeve, including an inner surface and an outer surface, extending from a first end to a second end along a longitudinal axis;
an annular cuff-ring groove, with a radiused fillet region, on the inner surface proximate the first end; and
a hardened case formed on the inner surface of the sleeve, the case extending under a base of the fillet region of the cuff-ring groove.

2. The cylinder liner of claim 1, wherein the case extends substantially along an entire length of the cuff-ring groove.

3. The cylinder liner of claim 1, wherein the cylinder liner is made of ductile cast iron.

4. The cylinder liner of claim 1, wherein the case extends substantially along an entire length of the sleeve.

5. The cylinder liner of claim 1, wherein a thickness of the case in a region proximate the cuff-ring groove is greater than a thickness of the case proximate the second end.

6. The cylinder liner of claim 1, wherein a thickness of the case decreases from a region proximate the fillet region to the second end of the sleeve.

7. The cylinder liner of claim 1, further including an annular flange extending radially outwardly from the outer surface proximate the first end.

8. The cylinder liner of claim 1, wherein the cuff-ring groove is a step-like groove that extends from the first end towards the second end of the sleeve.

9. A method of making a cylinder liner, comprising:
fabricating a hollow cylindrical sleeve, having an inner surface and an outer surface, that extends from a first end to a second end along a longitudinal axis;
forming a hardened case on the inner surface of the sleeve such that a thickness of the case proximate the first end is greater than a thickness of the case on other regions of the inner surface; and
machining a cuff-ring groove on the inner surface of the sleeve proximate the first end such that at least a portion of the case on a base of the cuff-ring groove is retained after the machining.

10. The method of claim 9, wherein fabricating the hollow cylindrical sleeve includes fabricating an annular flange that extends radially outwardly from the outer surface at the first end.

11. The method of claim 9 wherein machining the cuff-ring groove includes machining a radiused fillet region on the cuff-ring groove such that a portion of the case at the base of the fillet region is retained.

12. The method of claim 9, wherein forming the case includes forming the case by an induction hardening process.

13. The method of claim 12, wherein forming the case includes forming a thicker case proximate the first end compared to other regions of the inner surface by at least one of (i) decreasing a frequency of alternating magnetic field used in the induction hardening process proximate the first end compared to the other regions, (ii) increasing a power level of the alternating magnetic field proximate the first end compared to the other regions, and (iii) decreasing a scan rate of the induction hardening process proximate the first end compared to the other regions.

14. The method of claim 9, wherein machining the cuff-ring groove includes machining a step-like groove that extends from the first end towards the second end such that a portion of the case along substantially an entire length of the cuff-ring groove is retained after the machining.

15. The method of claim 9, wherein forming the case includes forming a case that is between about 0.7 and 3.5 mm thick proximate the first end and between about 0.7 and 1.8 mm proximate the second end.

16. The method of claim 15, wherein machining the cuff-ring groove includes machining the cuff-ring groove such that between about 0.5 and 1.5 mm thick layer of case is retained on the base of the cuff-ring groove.

17. An engine, comprising:
an engine block including one or more cylinder bores; and
a cylinder liner positioned in at least one of the one or more cylinder bores, the cylinder liner including:
a hollow cylindrical sleeve with an inner running surface extending from a first end to a second end along a longitudinal axis;
an annular cuff-ring groove that extends from the first end towards the second end;
a hardened case formed on the running surface by surface hardening, the case extending under at least a portion of the cuff-ring groove; and
a cuff-ring positioned in the cuff-ring groove.

18. The engine of claim 17, wherein the cylinder liner is made of ductile cast iron.

19. The engine of claim 17, wherein a first thickness of the case proximate the cuff-ring groove is between about 0.7 and 3.5 mm thick and a second thickness of the case proximate the second end is, smaller than the first thickness and, is between about 0.7 and 1.8 mm.

20. The engine of claim 17, further including an annular flange that extends radially outwardly from the first end of the cylinder liner.
